(19) United States
(12) Patent Application Publication
(10) Pub. No.: US 2007/0010987 A1
(43) Pub. Date: Jan. 11, 2007

(54) Lookahead instruction fetch processing for improved emulated instruction performance

(76) Inventors: Russell W. Guenthner, Glendale, AZ (US); Clinton B. Eckard, McMinnville, TN (US); Stefan R. Bohult, Phoenix, AZ (US); Charles P. Ryan, Phoenix, AZ (US)

Correspondence Address: James H. Phillips;Bull HN Information Systems Inc., MS B-55, 13430 North Black Canyon Highway, Phoenix, AZ, 85029-1310, US

(21) Appl. No.: 11/174,866

(22) Filed: Jul. 5, 2005

(51) Int. Cl. G06F 9/455

(52) U.S. Cl. 703/26

(57) ABSTRACT

In order to avoid hardware pipeline breaks and also to enhance performance when emulating a target system in a host system employing a central processing unit including a plurality of execution units, three major pieces of processing that are required for handling every emulated instruction are overlapped. This overlap includes: 1) the instruction fetch of the emulated instruction by the emulation software, 2) the branching of the emulation code based upon the opcode of the emulated instruction to be executed and 3) the actual execution processing for each emulated instruction. The branching of the emulation code, depending upon the opcode of each instruction, utilizes special instructions configured to minimize pipeline breaks on the host system hardware and thus to minimize the effective minimum host system processing time for the simplest emulated instructions.

### FIELD OF THE INVENTION

This invention relates to the art of computer system emulation and, more particularly, to the emulation of a Central Processing Unit in which the instruction set of legacy system hardware design is emulated by a software program. The invention is also applicable to virtual machines and virtual machine instruction processing.

### BACKGROUND OF THE INVENTION

Users of obsolete mainframe computers running a proprietary operating system may have a very large investment in proprietary application software and, further, may be comfortable with using the application software because it has been developed and improved over a period of years, even decades, to achieve a very high degree of reliability and efficiency.

As manufacturers of very fast and powerful commodity processors continue to improve the capabilities of their products, it has become practical to emulate the proprietary hardware and operating systems of powerful older computers on platforms built using “commodity” processors such that the manufacturers of the older computers can provide new systems which allow the users to continue to use their highly-regarded proprietary software on state-of-the-art new computer systems by emulating the older computer in software that runs on the new systems.

Accordingly, computer system manufacturers are developing such emulator systems for the users of their older systems, and the emulation process used by a given system manufacturer is itself subject to ongoing refinement and increases in efficiency and reliability.

Emulation of the instruction processing of a central processing unit in a computer system is also a method of controlling the access and increasing the security surrounding the running of a computer program with an example of such an approach being the definition of Sun Microsystem's Java Virtual Machine (JVM) which is well known in the industry.

Some historic computer systems now being emulated by software running on commodity processors have achieved performance which approximates or may even exceed that provided by legacy hardware system designs. An example of such hardware emulation is the Bull HN Information Systems (descended from General Electric Computer Department and Honeywell Information Systems) DPS 9000 system which is being emulated by a software package running on a Bull NovaScale system which is based upon an Intel Itanium 2 Central Processor Unit (CPU). The 64-bit Itanium processor is used to emulate the Bull DPS 9000 36-bit memory space and the GCOS 8 instruction set of the DPS 9000. Within the memory space of the emulator, the 36-bit word of the “target” DPS 9000 is stored right justified in the least significant 36 bits of the “host” (Itanium) 64-bit word. The upper 28 bits of the 64-bit word are typically zero for “legacy” code. Sometimes, certain specific bits in the upper 28 bits of the containing word are used as flags or for other temporary purposes, but in normal operation these bits are usually zero and in any case are always viewed by older programs in the “emulated” view of the world as being non-existent. That is, only the emulation program itself uses these bits.

In the design of the emulator system, careful attention is typically devoted to ensuring exact duplication of the legacy hardware behavior so that application programs will run without change and even without recompilation. Exact duplication of legacy operation is highly desirable to accordingly achieve exactly equivalent results during execution.

In order to achieve performance in an emulated system that at least approximates that achieved by the legacy system hardware, or in more general terms, in order to maximize overall performance, it is necessary that the code that performs the emulation be very carefully designed and very “tightly” coded in order to minimize breaks and maximize performance. These considerations require careful attention to the actual lowest level design details of the host system hardware, that is, the hardware running the software that performs the emulation. It also requires employing as much parallelization of operations as possible.

An Intel Itanium series 64-bit CPU is an excellent platform for building a software emulator of a legacy instruction set because it offers hardware resources that enable a high degree of potential parallelism in the hardware pipeline of the Itanium CPU. The Itanium CPU also provides instructions that allow for fast decision making and guidance by the software as to the most likely path of program flow for a reduction in instruction fetch breaks and overall improved performance. In particular, the Itanium architecture provides instructions that allow preloading of a “branch register” which informs the hardware of the likely new path of the instructions to be executed, with the “branch” instruction itself actually happening later. This minimizes the CPU pipeline breaks that are characteristically caused by branch instructions, and allows for typically well predicted branch instructions to be processed efficiently without CPU pipeline breaks wasting cycles. The branch look-ahead hardware of the Itanium CPU, and in particular a specific mechanism for loading and then using a branch register, allows for the emulation software to achieve a higher degree of overlap and, as a result, higher performance in emulated legacy system instruction processing.

### OBJECTS OF THE INVENTION

It is therefore a broad object of this invention to improve performance of a software program for emulation of a legacy instruction set by overlapping in time the processing of multiple legacy system instructions and also to structure the emulation system software in a manner that minimizes the pipeline breaks of the host system hardware. The word “legacy” is intended to refer to the instruction set and system being emulated, and the word “host” is used to refer to the machine which runs the software program performing the instruction set emulation. Branch prediction, branch registers and branch instructions, as exemplified in the Itanium series processors, are uniquely used to achieve instruction processing overlap and high utilization of hardware resources.

### SUMMARY OF THE INVENTION

Briefly, these and other objects of the invention are achieved by overlapping, in the emulation software, several major pieces of processing that are required for every instruction, and also utilizing multiple execution units to process the overlapped pieces of the legacy instruction execution to provide for a faster rate of overall legacy instruction processing. This overlap includes: 1) the instruction fetch of the legacy instruction by the emulation software, 2) the branching of the emulation code based upon the opcode of the emulated instruction to be executed and 3) the actual execution processing for each emulated instruction. The branching of the emulation code, depending upon the opcode of each instruction, utilizes special instructions of the host system hardware designed to minimize pipeline breaks and to minimize the minimum processing time for the simplest instructions. Together these improvements both increase the rate of instruction completion of the instructions of the host system by minimizing pipeline breaks, and also decrease the number of host system instructions and cycles required to process each individual legacy system instruction. The three degrees of overlap in this discussion are exemplary and other amounts of overlap could be chosen.

Emulation software, or software which emulates the instruction set of a processor or virtual machine, is somewhat unique in its program flow. Each legacy instruction that is encountered is emulated on the host system in a short burst of code, and this is followed by a subsequent, typically different, burst of code for each subsequent “opcode” or command that is encountered. The aspect that is unique is that the sequence of bursts is unpredictable because the opcodes that are encountered determine the program flow, and the sequence of opcodes encountered changes as every emulated program is processed.

The emulation code that is executed to perform each emulated instruction is relatively independent of that for other opcodes and so this tends to cause pipeline breaks in the host system hardware when the emulation software is running. Also, the host system hardware has a difficult time predicting the flow of the host system instructions in this environment, and the branch prediction mechanisms that are typical of modern high performance central processing units are rendered less accurate and less useful, resulting in the possibility of lower emulation performance.

A simplistic approach to emulation of instruction set processing without any overlap means that each instruction must be fetched and decoded, with the decode of the opcode and the branch to the emulation code to process that causing an unpredictable branch instruction. The fetch of the instruction takes time, the decode takes time and the execution processing takes time. If this work is done in linear sequence, that is without overlap, the delays for instruction fetch, decode and the unpredictable branch delay based upon the given opcode that is encountered are additive in determining the total processing time of every instruction.

Better performance than the simplistic approach can be achieved based upon the principles of this invention by utilizing special features of the Itanium series CPUs which allow for high amounts of instruction processing overlap and also provides for predictable branch delays when decisions must be made based upon unpredictable input data. Combining these two mechanisms in accordance with the present invention provides for a lowered minimum instruction processing time, and an improved utilization of hardware resources which significantly increases overall performance.

A first benefit of the overlapping the processing of several legacy system instructions is to minimize the effective processing time of each individual instruction using an approach similar to hardware pipelining. The overall time for each instruction is thus only the time of the largest piece, and not the sum of the pieces.

A second benefit is achieved by providing, in the host program code for processing each legacy instruction, both the programmed prediction of branches based on the opcodes discovered for each legacy instruction, and also the programmed delay time to allow the host system hardware to respond to each prediction without incurring delay.

Achieving overlapped processing in a software emulation program is not unlike that in a hardware based design. The difference is that in the software emulation the units of hardware available for processing must be shared between all stages of the pipeline whereas, in a hardware design, separate hardware resources are often provided for each level of the pipeline. This means that the program which performs the emulation must be programmed to process code for each and all levels of the pipeline simultaneously, and, in particular, the execution (emulation) code for each instruction must include embedded within it, the code for all other stages of the instruction processing pipeline. It is important to note that every piece of emulation code that pertains to processing any legacy opcode must include the code to process all other stages of the pipeline. It is also important to note that, when exceptions (unusual processing requirements) are discovered, the processing pipeline in the host system emulation software must be flushed and restarted in a manner similar to what is typical of a pipelined hardware design.

In the Itanium processors, a high degree of processing overlap is enabled by the processor's multiple execution units which can process up to six instructions in parallel within a single clock cycle. In typical sequential program flow, it is often difficult to utilize this many parallel resources. In accordance with aspects of this invention however, which provides for overlapped or pipelined processing in an emulation program, these parallel host system resources can be highly utilized. This is possible because the host system code for processing each level of the emulation software's pipeline is relatively independent of the code for other levels of the pipeline and this independence allows parallel resources to be effectively applied.

That is, by dividing the processing of each legacy instruction into several independent pieces, as in a hardware pipeline, the processing of each level of the pipeline can utilize different execution units of the host system in parallel, and without incurring breaks or interference. Thus, legacy instructions can be completed at a rate which is much greater than that which could be achieved if all aspects of each instruction were processed sequentially without overlap. In effect, the fetching of the legacy instruction from memory, the decode of each legacy instruction word in host program steps, and the branching to the host system target address for processing each legacy opcode can all be masked or hidden by doing that processing in parallel with the actual host system code required to execute each legacy instruction.

The Itanium processors also provide special hardware called branch registers which allow for processing of instructions to proceed in parallel with branch processing that normally would cause a pipeline break. Utilizing the branch registers in the emulation software enables processing to continue on other levels in the emulation software pipeline while inherent delays are taken in another level of the pipeline. More specifically, a branch register is a hardware register that can be loaded by the software at a time prior to the actual execution of a branch instruction. The loading of the branch register signals the host hardware that a branch will likely be later encountered and that the address of the target of the branch is being loaded into the branch register. Later, a branch “instruction” may be encountered which is the actual command to “take” the branch. That action is typically called a branch “go”. The delay between the loading of the branch register, and the branch instruction can be filled, for example, with useful work for other purposes, and in emulation software for the execution of another instruction and the decode of another third instruction. Overlapping the instruction fetch, the branch to the emulation code to perform execution, and the execution of the instruction itself allows the processing time for the overall instruction to be reduced to the time required for the longest piece.

It is found on the Intel Itanium 2 processor that a degree of overlap that achieves good performance is three. That is, three legacy instructions are processed in parallel by the host software emulation code. The first step in the processing of the legacy instruction is to fetch the instruction and extract the opcode. The second step is to load a host system branch register, wait the proper amount of time so that the predicted branch will not cause a host processor pipeline break and then take the branch. The third step is the actual instruction execution processing. The program code to perform all of the above three steps in parallel allows for the overall programming to proceed more quickly than the sequential processing of code to do those three steps sequentially. For the least complex legacy instructions, this overlapped approach allows the basic loop time for processing a single legacy instruction to be reduced to the basic loop time for an unpredictable branch on the host system hardware. On the Itanium 2 a processing time for each legacy instruction of approximately ten cycles or even less can be achieved which with an Itanium 2 CPU clock rate of 1.6 GigaHertz achieves a single legacy instruction execution time of less than seven nanoseconds, which is a rate of 160 million instructions per second (MIPS) or 160 MIPS.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a high level block diagram showing a “host” system emulating the operation of a legacy system, which does not physically exist, running legacy software;

FIG. 2 shows the format of an exemplary simple legacy code instruction which is emulated by emulation software on the host system;

FIG. 3 is a high level flowchart showing the prior art linear (or sequential) approach to emulating legacy code;

FIG. 4 is block diagram of a host system processor which is well adapted for use in practicing the present invention;

FIG. 5 is a flow table showing the parallel operation of the decoding and emulation of a plurality of successive legacy code instructions according to the present invention;

FIG. 6 shows the software “pipeline” effect achieved by the practice of the present invention; and

FIG. 7 is a diagram showing an exemplary six execution units processing up to six instructions in parallel and completing up to six instructions per host system central processing unit clock cycle.

### DESCRIPTION OF THE PREFERRED EMBODIMENT(S)

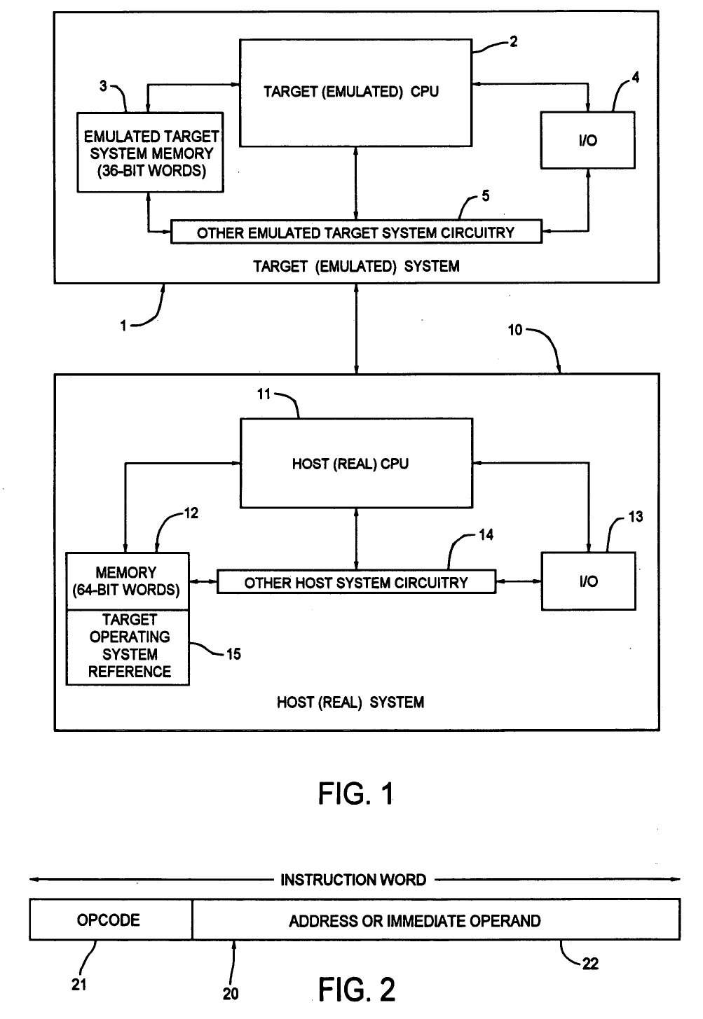

FIG. 1 illustrates an exemplary environment in which the invention finds application. More particularly, the operation of a target (emulated) “legacy” system is emulated by a host (real) system 10. The target system I includes an emulated central processing unit (CPU) 2 (which may employ multiple processors), an emulated memory 3, emulated input/output (I/O) 4 and other emulated system circuitry 5. The host (real) system 10 includes a host CPU 11, a host memory 12, host I/O 13 and other host system circuitry 14. The host memory 12 includes a dedicated target operating system reference space 15 in which the elements and components of the emulated system 1 are represented.

The target operating system reference space 15 also contains suitable information about the interconnection and interoperation among the various target system elements and components and a complete directory of the target system operating system commands which includes information on the steps the host system must take to “execute” each target system instruction in a program originally prepared to run on a physical machine using the target system operating system. It can be loosely considered that, to the extent that the target system 1 can be said to “exist” at all, it is in the target operating system reference space 15 of the host system memory 12. Thus, an emulator program running on the host system 2 can replicate all the operations of a legacy application program written in the target system operating system as if the legacy application program were running on a physical target system.

In a current state-of-the-art example chosen to illustrate the invention, a 64-bit Intel Itanium series processor is used to emulate the Bull DPS 9000 36-bit memory space and the instruction set of the DPS 9000 with its proprietary GCOS 8 operating system. Within the memory space of the emulator, the 36-bit word of the DPS 9000 is stored right justified in the least significant 36 bits of the “host” (Itanium) 64-bit word during the emulation process. The upper 28 bits of the 64-bit word are typically zero; however, sometimes, certain specific bits in the “upper” 28 bits of the “containing” word are used as flags or for other temporary purposes. In any case, the upper 28 bits of the containing word are always viewed by the “emulated” view of the world as being non-existent. That is, only the emulation program itself uses these bits or else they are left as all zeroes.

FIG. 2 shows the format of a simple legacy code instruction word 20 which includes an opcode field 21 and an address or operand field 22. Those skilled in the art will appreciate that an instruction word can contain several fields which may vary according to the class of instruction word, but it is the field commonly called the “opcode” which is of particular interest in explaining the present invention. The opcode of the legacy instruction is that which controls the program flow of the legacy program being executed. As a direct consequence the instruction word opcode of each sequential or subsequent legacy instruction controls and determines the overall program flow of the host system emulation program and the program address of the host system code to process each legacy instruction. Thus, the legacy instruction word opcode and the examination and branching of the host system central processor based on the opcode is an important and often limiting factor in determining the overall performance of the emulator. The decision making to transfer program control to the proper host system code for handling each opcode type is unpredictable and dependent on the legacy system program being processed. The order of occurrence and the branching to handle any possible order of instruction opcodes is unpredictable and will often defeat any branch prediction mechanism in the host system central processor which is trying to predict program flow of the emulation program.

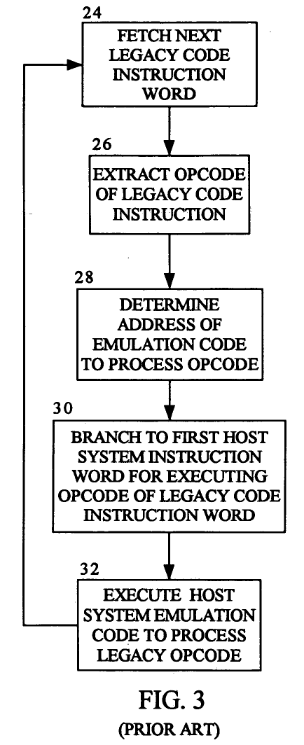

FIG. 3 is a flow chart showing the basic, linear, prior art approach to emulating legacy software in a host system. At step 24, the next legacy instruction word is fetched in an ongoing emulation process. At step 26, the opcode of the legacy instruction is extracted. At step 28, the memory address of the first instruction in the emulation code routine which is to be executed by the host system to emulate the legacy code instruction word is determined. At step 30, there is a branch to the first instruction word of the relevant emulation code; then, at step 32, the emulation code routine is executed, and only after this step is the next instruction word of the legacy code fetched at step 100.

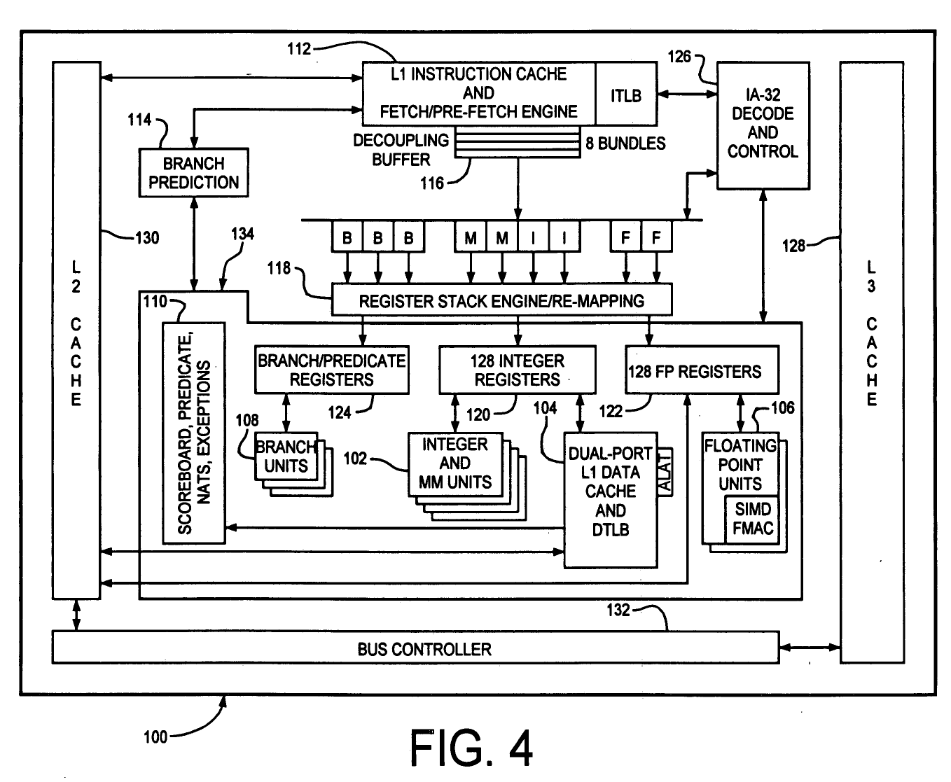

The subject invention can be practiced in host CPUs of any design but is particularly effective in those which include branch prediction registers which assist the hardware in handling branches and also benefits from CPUs employing parallel execution units and having efficient parallel processing capabilities. It has been found, at the state-of-the-art, that the Intel Itanium series of processors is an excellent exemplary choice for practicing the invention. Accordingly, attention is directed to FIG. 4 which is a block diagram of an Itanium 1 CPU which will be used to describe the present invention.

The CPU 100 employs Explicitly Parallel Instruction Computing (EPIC) architecture to expose Instruction Level Parallelism (ILP) to the hardware. The CPU 100 provides a six-wide and ten-stage pipeline to efficiently realize ILP.

The function of the CPU is divided into five groups. The immediately following discussion gives a high level description of the operation of each group.

Instruction Processing: The instruction processing group contains the logic for instruction prefetch and fetch 112, branch prediction 114, decoupling coupler 116 and register stack engine/remapping 118.

Execution: The execution group 134 contains the logic for integer, floating point, multimedia, branch execution and the integer and floating point register files. More particularly, the hardware resources include four integer units/four multimedia units 102, two load/store units 104, two extended precision floating point units and two single precision floating point units 106 and three branch units 108 as well as integer registers 120, FP registers 122 and branch and Predicate registers 124. In certain versions of the Itanium 2 architecture, six of the execution units can be utilized by the CPU simultaneously with the possibility of six instructions being started in one clock cycle, and sent down the execution pipeline. Six instructions can also be completed simultaneously.

Control: The control group 110 includes the exception handler and pipeline control. The processor pipeline is organized into a ten stage core pipeline that can execute up to six instructions in parallel each clock period.

IA-32 Execution: The IA-32 instruction group 126 group contains hardware for handling certain IA-32 instructions; i.e., 32-bit word instructions which are employed in the Intel Pentium series processors and their predecessors, sometimes in 16-bit words.

Three levels of integrated cache memory minimize overall memory latency. This includes an L3 cache 128 coupled to an L2 cache 130 under directive from a bus controller 130. Acting in conjunction with sophisticated branch prediction and correction hardware, the CPU speculatively fetches instructions from the L1 instruction cache in block 112. Software-initiated prefetch probes for future misses in the instruction cache and then prefetches specified code from the L2 cache into the L1 cache. Bus controller 132 directs the information transfers among the memory components.

The foregoing will provide understanding by one skilled in the art of the environment, provided by the Intel Itanium 1 series CPU, in which the present invention may be practiced. The architecture and operation of the Intel Itanium CPU processors is described in much greater detail in the Intel publication “Intel® Itanium™ Processor Hardware Developer's Manual” which may be freely downloaded from the Intel website and which is incorporated by reference herein.

The somewhat more performant Itanium 2 is presently preferred as the environment for practicing the present invention, but, of course, future versions of the Itanium series processors, or other processors which have the requisite features, may later be found to be still more preferred.

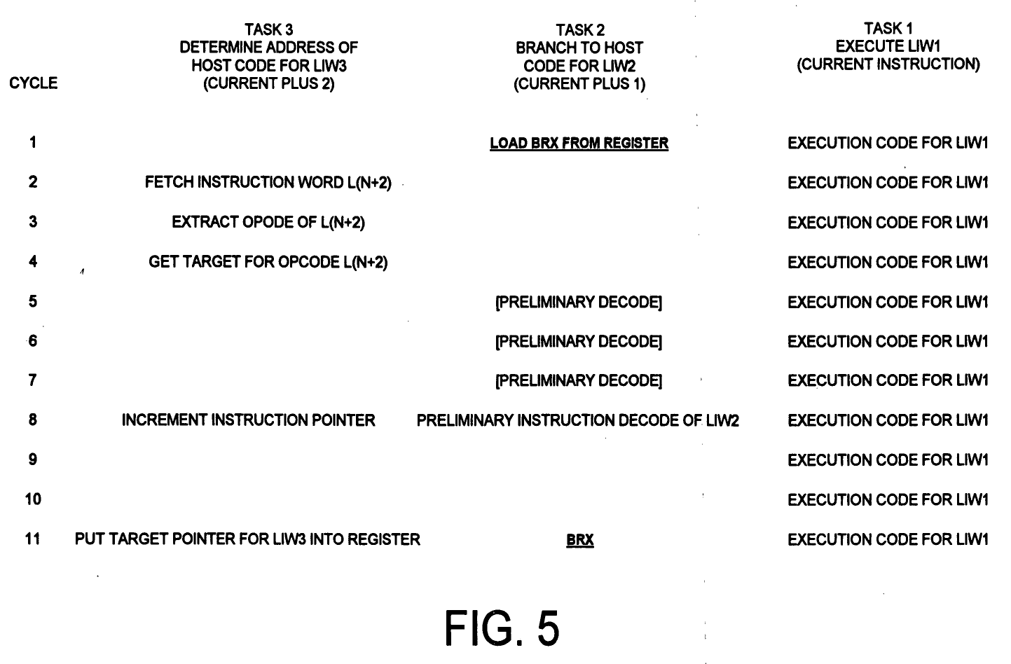

Referring now to FIG. 5, a flow table is presented which shows the operation of the invention in the emulation of three exemplary successive legacy code instructions, LIW0, LIW1 and LIW2 which, it will be assumed for illustrative purposes, have three different opcodes. The operation in the example is thus shown as consisting generally of three tasks performed simultaneously in 11 cycles. Task 1 (right column) is the “execution” phase of the instruction processing whose purpose is to process and “emulate” the work necessary to perform LIW1 (i.e., current legacy instruction). Task 2 (center column) is looking one instruction ahead and the purpose is to prepare the host system central processor to branch to the host system target address of the first instruction in the host code for emulating LIW2 (i.e., current legacy instruction 1 plus 1). Task 3 (left column) is looking two instructions ahead is associated with the processing to determine the target address of the host (emulation) code for LIW3 (i.e., current legacy instruction 1 plus 2).

These tasks will be performed in parallel by the host system CPU with the underlying goal of the design being to minimize the number of host system CPU cycles required to process a typical legacy instruction. The reduction in CPU host system cycles is accomplished by utilizing the parallel execution units efficiently to process one instruction LIW1 and also using other execution unit resources to look ahead and begin the processing required for both the next instruction LIW2, and the instruction after that LIW3. This lookahead processing means that the time-consuming branching based upon the decode of the opcode of the legacy instruction words has been already completed, and only the code specific to that which must be dependent upon that opcode remains to be done.

In practice it has been found in the Itanium which provides a large degree of parallelism and multiple execution units, that the execution phase which is task 1 is often shorter than the branching phase which is task 2. Therefore task 3 is performed separately so that only the time required to complete task 2 remains as the performance limit on the overall emulation program. In the exemplary diagrams this time to complete task 2 is shown as 11T or 11 cycles. In actual practice this can be shorter or longer depending on the actual code chosen to implement the overall emulation process.

Thus, during clock cycle 1: no action is taken for Task 3; for Task 2, the address of the first instruction in the emulation code for LIW2 is loaded into branch register BRX (i.e., the branch register assigned to the execution unit which will emulate LIW1) from a temporary register; and for Task 1, the execution of the emulation code for LIW1 will commence. During clock cycle 2: for Task 3, the legacy instruction word LIW3 is fetched; for Task 2, no action is taken; and for Task 1, the execution of the emulation code for LIW1 continues as necessary. During clock cycle 3: for Task 3, the target address for the first instruction in the emulation code for LIW3 is obtained (typically by matching the opcode of the legacy instruction to an address in a table lookup operation); for Task 2, no action is taken; and for Task 1, the execution of the emulation code for LIW0 continues as necessary.

During clock cycle 4: for Task 2, a delay is necessary, but this cycle may optionally be employed for preliminary decode as may be useful in analyzing other fields which may be present in LIW2; for Task 3, no action is taken; and for Task 1, the execution of the emulation code for LIW1 continues as necessary. During clock cycle 6: for Task 2, a delay is continued, but this cycle may also optionally be employed for preliminary decode of other fields which may be present in LIW2; for Task 3, no action is taken; and for Task 1, the execution of the emulation code for LIW1 continues as necessary. During clock cycle 7: the three Tasks continue as in clock cycle 6.

During clock cycle 8: for Task 3, an instruction pointer is incremented to prepare for the fetch of the next legacy instruction to be processed; for Task 2, preliminary instruction decode of LIW2 may be performed as necessary; for Task 1, the execution of the emulation code for LIW1 continues as necessary. During clock cycle 9: no action is take for Tasks 3 and 2 and, for Task 1, the execution of the emulation code for LIW0 continues as necessary. During clock cycle 10: the three Tasks continue as in clock cycle 9.

During clock cycle 11: for Task 3, the target address for the beginning of the emulation code for LIW3 is loaded into the temporary register; for Task 2, the branch to the beginning of the emulation code for LIW2 is taken; and, for Task 1, the processing of LIW1 is completed unless it has been previously completed.

The delay in processing Task 2 which is the taking of the branch dependent on the legacy instruction word opcode is required by the host system CPU hardware for maximum performance. This delay gives the CPU instruction prefetch unit time to respond to the predicted target address and to prefetch the expected instructions for processing the next instruction which will eventually become LIW1. These cycles 1 to 11 are repeated and at the completion of cycle 11, LIW1 is complete, LIW2 becomes LIW1 as the cycling begins anew at cycle 1, and LIW3 becomes LIW1.

It is noted that for complex execution processing the processing time of task 1 may extend beyond the exemplary 11 cycles indefinitely and the code for performing tasks 2 and 3 can be relaxed and fit into the task 1 execution processing in any way that is desired as long as proper delay for task 2 between the loading of the branch register shown in cycle 1, and the taking of the branch BRX in cycle 11. Without such delay a host system pipeline break would be incurred and degrade the overall performance of the emulation code.

Those skilled in the art will understand that the execution code for emulating one of a repertoire of legacy instructions may require execution of many host system instructions, but the eleven cycles available during Tasks 2 and 3 is general and adequate to preprocess any legacy instruction.

It is also noted that the degree of preliminary decode shown as part of Task 2 is optional but with purpose being to allow Task 1 for typical legacy instructions to be as short as possible. Since the preliminary decode is common to all instructions but not necessarily utilized by the execution code for all instructions there is a trade-off as to how much preliminary decode is to be done versus how much of the work should be left to be done by Task 1.

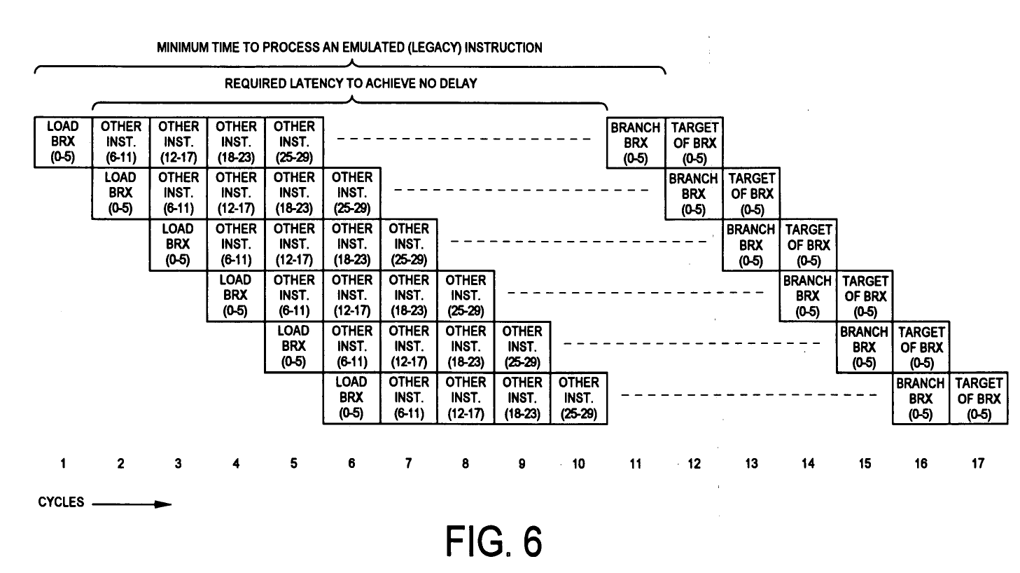

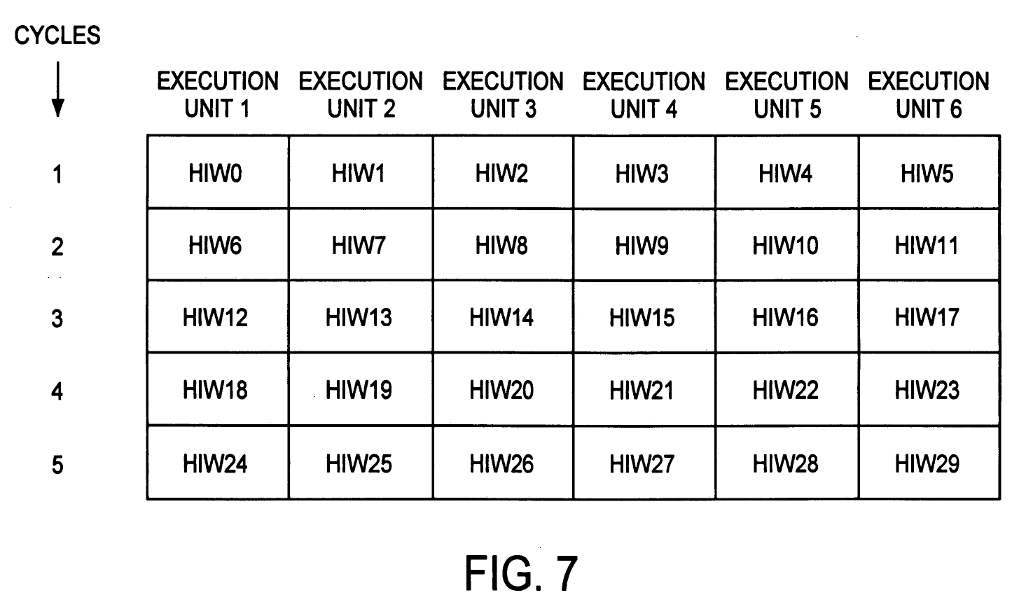

Referring to both FIG. 6 and FIG. 7, it is assumed in the example that six parallel execution units, as in the Itanium series CPUs, are available. Thus, FIG. 6 illustrates how the sequential branches for accessing successive host code routines for correspondingly successive legacy code instructions is carried out according to the invention to achieve a software pipeline effect which ensures that there are no hardware pipeline breaks in the hardware pipelines of the host CPU's execution units.

FIG. 7 shows, for the first five cycles only, but with respect to Host CPU Instruction Words HIW0-HIW29, how the host instruction code processing is methodically distributed among the six parallel execution units in a manner which achieves a very high degree of system utilization. In the exemplary 11T shown in FIG. 5 there would be 6 times 11 or 66 host system instruction words available for processing the three tasks 1, 2, and 3 for executing, branching and fetching of the respective instruction words.

It will be understood that both FIGS. 6 and 7 are only “snapshots” in time of an ongoing emulation process according to the invention.

While the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

It is particularly pointed out that neither the degree of parallelism shown in this discussion nor the boundaries which divide the tasks is fixed, and other degrees of parallelism or boundaries between tasks may be chosen without departing from the principles of the invention.

What is claimed is:

1. A mechanism for emulating the hardware of a first, target, computer system on a second, host, computer system comprising:
A) a host computer system including a central processing unit, and
B) overlapped program control for the host computer system providing for the processing of a plurality of at least three target system instructions simultaneously such that the completion rate of individual target instructions is greater than can be achieved without said overlapped program control.

2. The mechanism of claim 1 including also:
A) a central processing unit providing a plurality of execution units which can process at least three instructions in parallel employing a plurality of execution pipelines.

3. The mechanism of claim 1 including also:
A) a plurality of branch registers which can be loaded with the address of the target of a branch instruction at a time prior to the actual loading and execution of the branch instruction.

4. The mechanism of claim 2 including also:
A) a plurality of branch registers which can be loaded with the address of the target of a branch instruction at a time prior to the actual loading and execution of the branch instruction.

5. The mechanism of claim 1 in which the overlapped program control provides for precisely three target instructions to be in process simultaneously with processing divided such that:
A) a first target instruction word is processed with control program sequence performing the execution of the target instruction word, and
B) a second, susequent, target instruction word is processed with host system control making final preparation to branch to host system control dependent on the opcode of the second target instruction word, and
C) a third, subsequent, target instruction word is processed with host system control fetching and calculating the host system control instruction address for the opcode of the third target instruction word, and
D) pipeline control means for handling three target instruction word simultaneously

6. The mechanism of claim 2 in which the central processing unit comprises at least four parallel processing execution units.

7. The mechanism of claim 4 in which the central processing unit comprises at least four parallel processing execution units.

8. The mechanism of claim 5 in which the central processing unit comprises at least four parallel processing execution units.
